(19) United States
(12) Patent Application Publication
(10) Pub. No.: US 2007/0082112 A1
(43) Pub. Date: Apr. 12, 2007

(54) Edible oils and methods of making edible oils

(76) Inventors: Frank Kincs, Bourbonnais, IL (US); Carrie Abrassart, Kankakee, IL (US)

Correspondence Address: MCANDREWS HELD & MALLOY, LTD, 500 WEST MADISON STREET, SUITE 3400, CHICAGO, IL, 60661, US

(21) Appl. No.: 11/501,961

(22) Filed: Aug. 10, 2006

Related U.S. Application Data
(60) Provisional application No. 60/713,635, filed on Sep. 2, 2005.

(51) Int. Cl. A23D 9/00

(52) U.S. Cl. 426/601

(57) ABSTRACT

Edible oil blends are provided which have one or more of a desired linolenic acid content, a desired linolenic acid content, a desired saturated fatty acid content, a desired polyunsaturated fatty acid content, and/or a desired oleic acid content. Edible oil blends which are virtually trans free are also provided. Methods are provided for preparing such edible oils, including methods that normalize the fatty acid profile of the edible oils. Methods are also provided for using the edible oil blends for preparing foods. The edible oil blends typically comprise a first edible oil and a second edible oil, where the first edible oil is a low linolenic soybean oil, and the second edible oil is a palm oil (such as palm olein or palm stearin), and optionally the edible oil blend comprises a third edible oil such as high oleic canola oil. Alternatively the second, third, or additional edible oil can be selected from canola oil, cottonseed oil, safflower oil, soybean oil, olive oil, sunflower oil, palm oil, MCT oil, partially hydrogenated soybean oil, and trioleic oil.

### CROSS-REFERENCE TO RELATED APPLICATIONS

This application claims priority of U.S. Provisional Patent Application No. 60/713,635 filed Sep. 2, 2005, the disclosure of which is incorporated herein by reference.

### BACKGROUND OF THE INVENTION

Fats are a mixture of chemical compounds known as triglycerides. These compounds are formed from a reaction of a hydroxyl-containing compound known as glycerol and fatty acids. Fatty acids can be saturated or unsaturated, which refers to whether the fatty acid contains double bonds. Unsaturated fatty acids (which contain double bonds) can be in a “cis” or “trans” conformation. The “cis” conformation is where both hydrogen atoms are on the same side of the double bond, and the “trans” conformation is where the hydrogen atoms are on opposite sides of the double bonds. Different fatty acids contribute different physical properties to a fat. The fatty acids contribute not only different functional properties to the fat, but they also react differently in the body and therefore also contribute differently nutritionally.

Hydrogenation is a chemical reaction in which unsaturated bonds between carbon atoms are reduced by attachment of a hydrogen atom to each carbon. Hydrogenation has been used to make vegetable oils more solid and/or more stable and to increase the quality of many foods. Hydrogenation has also been used to convert liquid oil into solid form, providing the attributes of texture and eating quality desired by consumers in fried, baked or processed foods.

Partially hydrogenated oils became popular during the 1960's and 1970's as substitutes for natural animal fats because the partially hydrogenated oils contributed the same or similar desirable characteristics to foods, but provided less dietary cholesterol and relatively high levels of saturated fat. Later partially hydrogenated oils were also used to replace certain highly saturated vegetable oils. Partially hydrogenated vegetable oils have resistance against rancidity thus preserving freshness and extending the shelf life of foods containing them.

However hydrogenation can also increase the content of trans fatty acids (or trans fat). Trans fat can be formed when vegetable oils are processed by hydrogenation. Recent research has indicated that trans fats may behave similarly to saturated fats. Some studies suggest that trans fat may raise LDL and total cholesterol similar to saturates. Other studies indicate trans fats have lesser effects on blood cholesterol levels compared to saturated fats.

Various options have been suggested or tried to avoid trans fat. Among the options are vegetable oils having a high saturated fat content (such as coconut oil or palm kernel oil); vegetable oils having a high oleic acid content (such as high oleic canola oil, high oleic safflower oil, high oleic sunflower oil, very high oleic sunflower oil, and extra virgin olive oil); and vegetable oils having a low linolenic acid content (for example, Nutrium® low linolenic soybean oil or palm oil). However, in these options, the attribute(s) that confer stability can be variable. For example, the attribute may vary because oil seed fatty acid content is susceptible to external environmental conditions either during growing or post harvest processing.

It is desirable to provide an edible oil having the oxidative stability and/or other benefits of a hydrogenated oil without the drawbacks associated with hydrogenation. For example, it is also desirable to provide edible oil having a reduced content of polyunsaturated fatty acids without an increased content of trans fat. It is also desirable to reduce the variability generally associated with agricultural products and crop production.

### BRIEF SUMMARY OF THE INVENTION

In one aspect, the present invention relates to edible oil blends having a desired fatty acid profile and to methods for preparing such edible oil blends. For example, an edible oil blend is provided which has one or more of a desired linolenic acid content, a desired linolenic acid content, a desired saturated fatty acid content, a desired polyunsaturated fatty acid content, and/or a desired oleic acid content. Alternatively or additionally, the edible oil blend is virtually trans free. The present invention also relates to methods of preparing such edible oils, including methods that normalize the fatty acid profile of the edible oils.

In another aspect, methods are provided for preparing edible oil blends by blending a first edible oil (for example, an oil relatively low in linolenic acid) and a second edible oil (for example, an oil relatively high in oleic acid) in amounts sufficient to provide an edible oil blend having a desired fatty acid profile and/or other desirable characteristics. For example, the first and second edible oils can be blended in amounts sufficient to provide an edible oil blend having one or more of a desired linolenic acid content, a desired linolenic acid content, a desired polyunsaturated fatty acid content, and/or a desired oleic acid content. Alternatively or additionally, the edible oil blend is virtually trans free. In these methods, the edible oil blend and/or one or both of the first edible oil or the second edible oil may be prepared by refining and bleaching, and can be processed by brush hydrogenation and/or interesterification. Using these methods, an edible oil can be provided which is normalized and/or virtually trans free and/or has other desirable characteristics as described below.

In yet another aspect of the present invention, methods are provided for preparing an edible oil comprising blending a first portion of oil seeds (for example, relatively low linolenic oil seeds) and a second portion of oil seeds (for example, relatively high oleic oil seeds) in amounts sufficient to provide an edible oil blend having a desired fatty acid profile and/or other desirable characteristics, such as being normalized and/or virtually trans free.

In a further aspect of the present invention, methods are provided for using the edible oil blends disclosed herein. Methods are provided for frying, baking, broiling, roasting, or otherwise cooking food in an edible oil blend. The methods can include contacting a food with an edible oil blend and heating the edible oil blend, for example to a temperature of 325° F. or higher. Methods for preparing a food comprise combining an edible oil blend in a food such as a bakery product.

### BRIEF DESCRIPTION OF THE DRAWINGS

FIG. 1 is a graph of anisidine values from fry life testing for two edible oil blends, a partially hydrogenated soybean oil, and a high oleic canola oil.

FIG. 2 is a graph of dielectric values from fry life testing for two edible oil blends, a partially hydrogenated soybean oil, and a high oleic canola oil.

FIG. 3 is a graph of red color values from fry life testing for two edible oil blends, a partially hydrogenated soybean oil, and a high oleic canola oil.

FIG. 4 is a graph of values for oxidative stability index from fry life testing for two edible oil blends, a partially hydrogenated soybean oil, and a high oleic canola oil.

FIG. 5 is a graph of polymer content values from fry life testing for two edible oil blends, a partially hydrogenated soybean oil, and a high oleic canola oil.

### DETAILED DESCRIPTION OF THE INVENTION

The present invention relates to novel edible oils and novel methods of preparing those edible oils. Novel methods are provided for the production of improved edible oils, for example, edible oils that are normalized and/or virtually trans free and/or having other desirable characteristics, as described in this patent disclosure. The present edible oil blends typically comprise a first edible oil and a second edible oil (and optionally, a third edible oil, a fourth edible oil, or additional edible oils). For example, the first edible oil can be a low linolenic soybean oil, and the second edible oil can be a palm oil (such as palm olein or palm stearin), and optionally the edible oil blend comprises a third edible oil such as high oleic canola oil. Alternatively the second, third, or additional edible oil can be selected from canola oil, cottonseed oil, safflower oil, soybean oil, olive oil, sunflower oil, palm oil, MCT oil, partially hydrogenated soybean oil, and trioleic oil. Methods are also provided for making and using such edible oil blends.

In one aspect, the present invention relates to edible oil blends having a desired fatty acid profile and to methods for preparing such edible oil blends. The desired fatty acid profile can comprise one or more of a desired linolenic acid content, a desired linoleic acid content, a desired polyunsaturated fatty acid content, and/or a desired oleic acid content. For example, an edible oil blend is provided which has a linolenic acid content of from about 0.5% to about 6%. As another example, an edible oil blend is provided which has a linoleic acid content of from about 17% to about 58%. As yet another example, an edible oil blend is provided which has a total saturated fatty acid content (that is, the content of palmitic acid, stearic acid and any other saturated fatty acids) of from about 7% to about 49%. As another example, an edible oil blend is provided which has a total polyunsaturated fatty acid content (that is, the content of linolenic acid and linoleic acid) of from about 18% to about 61%. As another example, an edible oil blend is provided which has an oleic acid content of from about 15% to about 69%. As yet another example, an edible oil blend is provided which is virtually trans free. As a further example, an edible oil blend is provided which has a desired ratio of oleic acid to linolenic acid content. As a still further example, an edible oil blend is provided which has a ratio of oleic acid to linolenic acid content of from about 5.0 to about 68.4, alternatively from about 4.0 to about 70.0. As an additional example, an edible oil blend is provided which has a desired ratio of combined oleic acid and linoleic acid content to linolenic acid content (% oleic acid+% linoleic acid/% linolenic acid). The present invention also relates to methods of preparing such edible oil blends, and it further relates to methods by which the fatty acid profile of edible oils may be normalized.

The desired fatty acid profile can comprise one or more desired fatty acid contents, such as a desired linolenic acid content and/or a desired linolenic acid content and/or a desired saturated fatty acid content and/or a desired polyunsaturated fatty acid content and/or a desired oleic acid content. The desired fatty acid profile, or one or more desired fatty acid contents, can be normalized by the methods provided by the present disclosure.

For example, an edible oil blend is provided which has a maximum linolenic acid content of about 0.6%, alternatively about 0.7%, alternatively about 0.8%, alternatively about 0.9%, alternatively about 1.0%, alternatively about 1.1%, alternatively about 1.2%, alternatively about 1.3%, alternatively about 1.4%, alternatively about 1.5%, alternatively about 1.6%, alternatively about 1.7%, alternatively about 1.8%, alternatively about 1.9%, alternatively about 2.0%, alternatively about 2.1%, alternatively about 2.2%, alternatively about 2.3%, alternatively about 2.4%, alternatively about 2.5%, alternatively about 2.6%, alternatively about 2.7%, alternatively about 2.8%, alternatively about 2.9%, alternatively about 3.0%, alternatively about 3.1%, alternatively about 3.2%, alternatively about 3.3%, alternatively about 3.4%, alternatively about 3.5%, alternatively about 3.6%, alternatively about 3.7%, alternatively about 3.8%, alternatively about 3.9%, alternatively about 4.0%, alternatively about 4.1%, alternatively about 4.2%, alternatively about 4.3%, alternatively about 4.4%, alternatively about 4.5%, alternatively about 4.6%, alternatively about 4.7%, alternatively about 4.8%, alternatively about 4.9%, alternatively about 5.0%, alternatively about 5.1%, alternatively about 5.2%, alternatively about 5.3%, alternatively about 5.4%, alternatively about 5.5%, alternatively about 5.6%, alternatively about 5.7%, alternatively about 5.8%, alternatively about 5.9%, alternatively about 6.0%.

Alternatively or additionally, an edible oil blend is provided which has a minimum linolenic acid content of about 0.5%, alternatively about 0.6%, alternatively about 0.7%, alternatively about 0.8%, alternatively about 0.9%, alternatively about 1.0%, alternatively about 1.1%, alternatively about 1.2%, alternatively about 1.3%, alternatively about 1.4%, alternatively about 1.5%, alternatively about 1.6%, alternatively about 1.7%, alternatively about 1.8%, alternatively about 1.9%, alternatively about 2.0%, alternatively about 2.1%, alternatively about 2.2%, alternatively about 2.3%, alternatively about 2.4%, alternatively about 2.5%, alternatively about 2.6%, alternatively about 2.7%, alternatively about 2.8%, alternatively about 2.9%, alternatively about 3.0%, alternatively about 3.1%, alternatively about 3.2%, alternatively about 3.3%, alternatively about 3.4%, alternatively about 3.5%, alternatively about 3.6%, alternatively about 3.7%, alternatively about 3.8%, alternatively about 3.9%, alternatively about 4.0%, alternatively about 4.1%, alternatively about 4.2%, alternatively about 4.3%, alternatively about 4.4%, alternatively about 4.5%, alternatively about 4.6%, alternatively about 4.7%, alternatively about 4.8%, alternatively about 4.9%, alternatively about 5.0%, alternatively about 5.1%, alternatively about 5.2%, alternatively about 5.3%, alternatively about 5.4%, alternatively about 5.5%, alternatively about 5.6%, alternatively about 5.7%, alternatively about 5.8%, alternatively about 5.9%.

Any minimum content and any maximum content of linolenic acid, as specified above, may be combined to define a range, providing that the minimum selected is equal to or less than the maximum selected. For example, an edible oil blend is described which has a linolenic acid content in the range of about 0.5% to about 6.0%.

As an alternative or in addition to the desired linolenic acid content, the desired fatty acid profile can comprise one or more other desired fatty acid contents, such as a desired linolenic acid content.

For example, an edible oil blend is provided which has a maximum linolenic acid content of about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%, alternatively about 50%, alternatively about 51%, alternatively about 52%, alternatively about 53%, alternatively about 54%, alternatively about 55%, alternatively about 56%, alternatively about 57%, alternatively about 58%.

Alternatively or additionally, an edible oil blend is provided which has a minimum linolenic acid content of about 17%, alternatively about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%, alternatively about 50%, alternatively about 51%, alternatively about 52%, alternatively about 53%, alternatively about 54%, alternatively about 55%, alternatively about 56%, alternatively about 57%.

Any minimum content and any maximum content of linolenic acid, as specified above, may be combined to define a range, providing that the minimum selected is equal to or less than the maximum selected. For example, an edible oil blend is described which has a linolenic acid content in the range of about 17% to about 58%.

As an alternative or in addition to the desired linolenic acid content and/or the desired linolenic acid content, the desired fatty acid profile can comprise one or more other desired fatty acid contents, such as a desired saturated fatty acid content.

For example, an edible oil blend is provided which has a maximum saturated fatty acid content of about 8%, alternatively about 9%, alternatively about 10%, alternatively about 11%, alternatively about 12%, alternatively about 13%, alternatively about 14%, alternatively about 15%, alternatively about 16%, alternatively about 17%, alternatively about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%.

Alternatively or additionally, an edible oil blend is provided which has a minimum saturated fatty acid content of about 7%, alternatively about 8%, alternatively about 9%, alternatively about 10%, alternatively about 11%, alternatively about 12%, alternatively about 13%, alternatively about 14%, alternatively about 15%, alternatively about 16%, alternatively about 17%, alternatively about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%.

Any minimum content and any maximum content of saturated fatty acid, as specified above, may be combined to define a range, providing that the minimum selected is equal to or less than the maximum selected. For example, an edible oil blend is described which has a saturated fatty acid content in the range of about 7% to about 49%.

As an alternative or in addition to the desired linolenic acid content and/or the desired linolenic acid content and/or the desired saturated fatty acid content, the desired fatty acid profile can comprise one or more other desired fatty acid contents, such as a desired polyunsaturated fatty acid content.

For example, an edible oil blend is provided which has a maximum polyunsaturated fatty acid content of about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%, alternatively about 50%, alternatively about 51%, alternatively about 52%, alternatively about 53%, alternatively about 54%, alternatively about 55%, alternatively about 56%, alternatively about 57%, alternatively about 58%, alternatively about 59%, alternatively about 60%, alternatively about 61%.

Alternatively or additionally, an edible oil blend is provided which has a minimum polyunsaturated fatty acid content of about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%, alternatively about 50%, alternatively about 51%, alternatively about 52%, alternatively about 53%, alternatively about 54%, alternatively about 55%, alternatively about 56%, alternatively about 57%, alternatively about 58%, alternatively about 59%, alternatively about 60%.

Any minimum content and any maximum content of polyunsaturated fatty acid, as specified above, may be combined to define a range, providing that the minimum selected is equal to or less than the maximum selected. For example, an edible oil blend is described which has a polyunsaturated fatty acid content in the range of about 18% to about 61%.

As an alternative or in addition to the desired linolenic acid content and/or the desired linolenic acid content and/or the desired saturated fatty acid content and/or the desired polyunsaturated fatty acid content, the desired fatty acid profile can comprise one or more other desired fatty acid contents, such as a desired oleic acid content.

For example, an edible oil blend is provided which has a maximum oleic fatty acid content of about 16%, alternatively about 17%, alternatively about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%, alternatively about 50%, alternatively about 52%, alternatively about 53%, alternatively about 54%, alternatively about 55%, alternatively about 56%, alternatively about 57%, alternatively about 58%, alternatively about 59%, alternatively about 60%, alternatively about 61%, alternatively about 62%, alternatively about 63%, alternatively about 64%, alternatively about 65%, alternatively about 66%, alternatively about 67%.

Alternatively or additionally, an edible oil blend is provided which has a minimum oleic fatty acid content of about 15%, alternatively about 16%, alternatively about 17%, alternatively about 18%, alternatively about 19%, alternatively about 20%, alternatively about 21%, alternatively about 22%, alternatively about 23%, alternatively about 24%, alternatively about 25%, alternatively about 26%, alternatively about 27%, alternatively about 28%, alternatively about 29%, alternatively about 30%, alternatively about 31%, alternatively about 32%, alternatively about 33%, alternatively about 34%, alternatively about 35%, alternatively about 36%, alternatively about 37%, alternatively about 38%, alternatively about 39%, alternatively about 40%, alternatively about 41%, alternatively about 42%, alternatively about 43%, alternatively about 44%, alternatively about 45%, alternatively about 46%, alternatively about 47%, alternatively about 48%, alternatively about 49%, alternatively about 50%, alternatively about 52%, alternatively about 53%, alternatively about 54%, alternatively about 55%, alternatively about 56%, alternatively about 57%, alternatively about 58%, alternatively about 59%, alternatively about 60%, alternatively about 61%, alternatively about 62%, alternatively about 63%, alternatively about 64%, alternatively about 65%, alternatively about 66%.

Any minimum content and any maximum content of oleic acid, as specified above, may be combined to define a range, providing that the minimum selected is equal to or less than the maximum selected. For example, an edible oil blend is described which has an oleic acid content in the range of about 15% to about 67%.

The present methods can provide edible oil blends having one or more desirable characteristics. Among the desirable characteristics for food applications are functional characteristics, such as taste, oxidative stability, and structure (e.g., when liquid oils described herein are blended with one or more solid fats to produce a shortening) and nutritional characteristics, such as nutritional value, ratio of one or more polyunsaturated fatty acids to monounsaturated fatty acids, and availability of essential fatty acids. For example, the present methods provide edible oils having commercial frying performance based on or substantially equivalent to commodity edible oils (such as soybean, canola, and palm oils). The present invention provides for novel edible oils having desirable frying performance, including desirable fry life properties. The present invention provides for novel edible oils having improved oxidative stability. For example, the novel edible oils preferably have an oxidative stability index better than, the same as, or comparable to typical frying shortening products. The edible oils of the present invention may have further utility in non-food applications, for which there are other characteristics contemplated, by way of example only, heat transfer properties, oxidative stability, lubricity, and dielectric properties.

The present invention provides edible oil blends and method of making edible oil blends wherein the edible oil blends are non-hydrogenated and/or are virtually trans free, and the edible oil blends can have the same or comparable (e.g., commercially competitive) fry life performance and/or other properties as commodity edible oils or commercially available edible oils, including oils that are hydrogenated or partially hydrogenated. Non-hydrogenated oils are those that have not been subjected to a hydrogenation process for reducing double bonds in the fatty acids.

The present edible oil blends can be used in a wide variety of applications. For example, the present edible oil blends can be used for frying (for example, deep-frying or stir-frying), baking, broiling, roasting, or otherwise cooking foods. The present edible oil blends can also be used as or in dipping oils, spray oils, bottled oils, or salad dressings. Moreover, some embodiments of the present edible oil blends are suitable as shortenings and can be used in cakes, icings, pie crusts, cookies, and bakery products.

The present edible oil blends can be used in various foods and/or for the preparation of a various foods. Examples of such food include foods which usually contain or are prepared with oils and/or fats, such as baked foods, fried foods, dessert foods (including frozen desserts, cakes and cookies), margarines, salad dressing, mayonnaise, cheeses, spreads, dips, condiments or seasonings for breads, vegetables, meats, fish, pastas, and other foods. For example, various edible oil blends described herein may be used for frying or otherwise cooking French fries, potato chips, corn chips, and/or tortilla chips. As other examples, various edible oil blends described herein may be used for preparing popcorn or crackers.

The present edible oil blends can be used for solid shortenings. To obtain a solid shortening, it may be desirable to partially hydrogenate the edible oil blends or combine the edible oil blends with a solid edible oil, such as a fully hydrogenated oil. Solid shortenings comprising the present edible oil blends may be especially desirable for bakery products.

Edible oils include naturally occurring oils (such as oil obtained from oil seeds) and/or synthetic oils (such as medium chain triglycerides). Oil seeds are agricultural products that can be processed using various steps to obtain the oil contained in the oil seed. Oil seeds include canola, corn, soybean, safflower, sunflower, oil fruits, and many others. Vegetable oils can be produced from oil seeds using various steps that are known and used in the vegetable oil industry. Vegetable oils include cooking oils, edible oils, shortenings, industrial oils and oils having many other uses.

Oil can be obtained from the seed by various physical and/or chemical processes, such as crushing and/or extraction. Oilseed processing includes steps for refining, bleaching and deodorizing the oil obtained from the seed. Additional details regarding the processing of oilseeds can be found in “Rapeseed and canola oil: production, processing, properties and uses” (F. D. Gunstone ed.) Oxford: Blackwell (2004) and “Baileys Industrial Oil and Fat Products,” Wiley-lnterscience Publishers (2005), both of which are incorporated by reference herein in their entireties.

The term normalized refers to reduced variability in fatty acid profile in oil produced in a given time period (such as over a period of weeks, months, or a growing season), or in oil produced by a given facility, or in oil from oil seed grown in a given region. In accordance with the invention, a normalized edible oil may have reduced variability in the fatty acid profile so that its characteristics and properties may remain consistent over a period of time. It is contemplated that using presently-employed commercial blending processes in accordance with the teachings of the present patent disclosure, the variability of the fatty acid profile may be kept within the range of about ±3%, while the variability may be reduced even further to the range of about ±1% by making suitable process and equipment modifications as will be appreciated by one skilled in the present art. The present methods can be employed for normalizing an edible oil, whereby the consistency of the fatty acid profile of a marketed edible oil product is increased. The present disclosure provides methods for preparing normalized edible oils. Such methods may be desirable for quality control for an edible oil product that will be marketed.

The present disclosure provides an edible oil that is virtually trans free. Such oil has little or no trans fat, though trans fat resulting from deodorization may be present. The term “virtually trans free” refers to a delivered trans fat level below 0.5 g for the reference amount for a given item (such as the 14 g reference amount for frying shortenings established by the USDA). For example, a 14 g quantity of a virtually trans free edible oil will have less than 0.5 g trans fat. Virtually trans free edible oils are highly desired by the food industry. Alternatively, an edible oil is provided having less than 3% or about 3% trans fat, alternatively less than 1% or about 1% trans fat, alternatively less than 0.5% or about 0.5% trans fat. Alternatively, an edible oil is provided that is essentially free of trans fats. Alternatively, an edible oil is provided that contributes less than 0.5 grams trans fat per serving to a food (such as a baked food) prepared with a standard quantity of that edible oil for that food.

The present disclosure provides edible oil blends comprising a first edible oil and a second edible oil, where the first edible oil is a low linolenic soybean oil. Low linolenic soybean oil is commercially available under the mark Nutrium® and is readily distinguishable from conventional soybean oils. For example, a sample of Nutrium® low linolenic soybean oil was found to have a linolenic acid content of 2.8%, a stearic acid content of 4.3%, an oleic acid content of 25.3%, and a linolenic acid content of 56.0%. Suitable low linolenic soybean oils include those having linolenic acid contents of about 6% or less, alternatively about 3% or less, alternatively about 2% or less, and one or more of a stearic acid content of 25% or less, alternatively 5% or less, a linoleic acid content of 25% or more, alternatively 50% or more, and an oleic acid content of 50% or less, alternatively 25% or less.

In one aspect, the present invention relates to an edible oil having a desired linolenic acid content (for example, a linolenic acid content of about 6% or less, alternatively about 3% or less, alternatively about 2% or less). The edible oil can be normalized and/or virtually trans free. As another aspect, the present invention relates to methods for making such edible oils. The edible oil can be prepared by a method which includes one or more of the methods described herein, including by combinations of the following methods.

A method for preparing an edible oil comprises blending a first portion of oil seeds (for example, high oleic oil seeds) and a second portion of oil seeds, (for example, low linolenic oil seeds). For example, the method can comprise blending low linolenic soybean seeds and high oleic canola oil seeds. The oil seeds are blended in a ratio effective to produce an edible oil having a desired fatty acid content, for example, a linolenic acid content of from about 3.1% to about 5.4%.

Another method for preparing an edible oil comprises blending a first portion of oil seeds (for example, high oleic oil seeds) and a second portion of oil seeds (for example, low linolenic oil seeds), producing an edible oil from the oil seeds, and adding one or more antioxidants to the edible oil. For example, the method can comprise blending low linolenic soybean seeds and soybean seeds. Suitable seeds are blended in a ratio effective to produce an edible oil having a desired fatty acid content, for example, a linolenic acid content of from about 3.0% to about 4.8%. The method further comprises adding one or more antioxidants to the edible oil. The antioxidant(s) can be added before or after the oil is deodorized.

Another method for preparing an edible oil comprises blending a first edible oil (for example, relatively low linolenic edible oil) with a second edible oil. For example, the method can comprise blending low linolenic soybean oil and an oil selected from the group consisting of canola oil, cottonseed oil, soybean oil, partially hydrogenated soybean oil, palm oil (olein fraction), or MCT oil. Palm oil may be comprised of or provided as one or more fractions of palm oil, such as palm olein, palm superolein, palm midfraction, palm stearin, palm kernel olein, palm kernel stearin. As another example, the second edible oil can be corn oil, present in an amount of about 40% or less, or present in an amount of about 45% or more. Suitable oils are blended in a ratio effective to produce an edible oil having a linolenic acid content of about 6.0% or less and which is virtually trans free. The oil blending can comprise blending one or more of (a) medium chain saturated fatty acid containing oils, (b) long chain high oleic acid containing oils, and/or (c) linolenic acid reduced oils. Oils can be blended subsequent to refining and bleaching and prior to deodorization. This aspect of the invention can be achieved by the blending of additional oils with refined and bleached oils, followed by deodorization.

Another method for preparing an edible oil comprises blending a first edible oil (for example, low linolenic edible oil) and a second edible oil, and adding one or more antioxidants to the edible oil. The antioxidant(s) can be added either before or after the blending; that is, the antioxidant(s) can be added to the first edible oil and/or the second edible oil, and/or to the blended edible oil. For example, the method can comprise blending low linolenic soybean oil and soybean oil, and adding an antioxidant(s). Suitable oils are blended in a ratio effective to produce an edible oil having a desired fatty acid content, for example, a linolenic acid content of about 6% or less, alternatively about 4% or less. The method further comprises adding one or more antioxidants to the edible oil. The antioxidant(s) can be added before or after the oil is deodorized.

Another method for preparing an edible oil comprises processing an edible oil by brush hydrogenation to an extent sufficient to provide an edible oil having a desired fatty acid profile, such as a desired fatty acid content, for example, a virtually trans free edible oil having a linolenic acid content of about 6% or less, alternatively about 4% or less.

Brush hydrogenation refers to hydrogenation that provides small increases in saturation in order to improve the stability and shelf life of an edible oil. Partial hydrogenation, or “brush hydrogenation,” involves a limited degree of reaction by hydrogenation. Partial hydrogenation may be employed, for example, to improve the stability of oils and to provide increased usefulness by imparting a semi-solid consistency to the oil for many food applications.

Hydrogenation and partial hydrogenation both include, without limitation, the treatment of an oil with H₂ and a catalyst to decrease double bonds and increase saturated bonds. The hydrogenation process can be controlled and can be stopped at any desired point. The hydrogenation reaction rate depends on a number of different variables, including without limitation, the nature of the substance to be hydrogenated, the nature and concentration and type of the catalyst, the reaction pressure (for example, the concentration of hydrogen), the temperature, the degree of agitation, and reactor design. As hydrogenation progresses, there is generally a gradual increase in the melting point of the fat or oil. More detail regarding hydrogenation and hydrogenated products can be found in H. B. W. Patterson, “Hydrogenation of Fats and Oils: Theory and Practice” (1994) and in W. Himmelsbach et al., “Increased Productivity in Hydrogenation of Edible Fats and Oils,” Oil Mill Gazetteer, Vol. 109, pp. 11-15, March 2004 (which are incorporated by reference herein).

In brush hydrogenation, selective reaction conditions are used with an appropriate nickel catalyst. Typical selective reaction conditions of nickel catalyst include a catalyst concentration of from about 0.2% w/w to about 0.5% w/w, reaction temperatures up to about 250° C., and/or pressures up to and including about 50 psig.

Another method for preparing an edible oil comprises processing an edible oil by hydrogenation as described in U.S. Patent Application Publication No. 2004/0146626 A1 (Higgins) (which is incorporated by reference herein) to an extent sufficient to produce an edible oil having a desired fatty acid profile. For example, the Higgins publication provides a nickel catalyst having a plurality of its reactive sites deadened or poisoned by a catalyst conditioning chemical. An edible fat source is hydrogenated in the presence of this catalyst so as to provide hydrogenated edible fat having not more than about 10 percent of trans-hydrogenation. Thus, in any of the present methods, an edible oil may be hydrogenated using a conditioned catalyst. The Higgins publication discloses that a starting oil is subjected to a controlled hydrogenation procedure which strongly disfavors the formation of trans-stereoisomers. The controlled hydrogenation strongly favors cis-stereoisomers at the hydrogenation site.

Catalysts of this type which effect the controlled hydrogenation described herein preferably are prepared by conditioning existing nickel catalysts. This conditioning involves subjecting a nickel catalyst to a conditioning chemical such that catalyst is rendered less active for the trans isomer formation.

Suitable conditioning chemicals are selected from the group consisting of organic acids, nitrogenous bases, phosphoric acids and organic acid phosphates. A particularly preferred conditioning chemical is phosphoric acid, such as 75 percent food grade acid. The conditioning chemical can be provided in the form of phosphated mono- and di-glycerides. When provided in this latter form, the conditioning chemical and the catalyst are combined at a ratio of between about, 0.1 to 1 and about 0.3 to 1. Preferably, this ratio is between about 0.15 to 1 and about 0.25 to 1. Referring further to the phosphated mono- and di-glycderides, it is preferred that the phosphated mono- and di-glyceride mixture be one which is not substantially neutralized. In order for this to be adequately active, it can be unneutralized material, or it can be very slightly neutralized.

Desirably, the nickel catalyst is a narrow pore catalyst. Catalysts of this type include Nysofact® or other industrial catalysts suitable for use in the edible oil industry. Other narrow pore nickel catalysts include the Synetix 9912 catalyst. Other catalysts include those within the Nysosel line of nickel catalysts available from Englehard. The conditioned catalyst can comprise a narrow pore selective nickel catalyst composition having a plurality of active sites which are conditioned with a conditioning chemical selected from the group consisting of a phosphoric acid, an organic acid phosphate, and combinations thereof.

The conditioned catalyst composition preferably is combined in a slurry tank or the like. When the conditioned catalyst is formed by combining the nickel catalyst with the conditioning chemical, such as within the slurry tank, the interaction between them typically will proceed for at least about one half an hour, and generally no longer than about one hour and one half. The conditioned catalyst is charged into the hydrogenation or cooking vessel having the edible oil to be subjected to hydrogenation. The conditioned catalyst charge is at a level of about 0.015 to about 0.025 weight percent, based upon the total weight of the charge into the hydrogenation vessel. Hydrogenation is carried out in equipment generally known in the art. Such hydrogenation takes place at an elevated temperature and an elevated pressure. A typical temperature range is between about 260° F. and about 280° F. (about 127° C. to 138° C.). A typical hydrogenation pressure is between about 40 psig and about 50 psig.

Another method for preparing an edible oil comprises processing an edible oil by interesterification. For example, low linolenic soybean oil can be interesterified with one or more of medium chain fatty acids (C8, C10, and C12), palm fruit oil variants, tri-oleic (a glyceride of 3 oleic acid molecules), or oleic acid (as described in Nakhasi et al U.S. Pat. No. 6,769,959). Interesterification involves an exchange of acyl groups among triglycerides. Acyl groups may exchange positions within a triglyceride or among triglyceride molecules. The interesterification process is an oil modification technology and can be used to modify the physical properties of an oil and/or fat blend. Interesterification works, at least in part, by rearranging the fatty acid groups within and between the different triglycerides. The process can be applied directly to natural derived oils or fats or to hydrogenated or fractionated oils. Interesterification can be induced, for example, by chemical or enzymatic catalysts. Interesterification can provide a random distribution of the fatty acids, corresponding to the laws of probability (for example, interesterification can be carried out to an equilibrium condition, at which point the fatty acids assume an almost random distribution among triglycerides). Alternatively, interesterification can provide a directed distribution of the fatty acids (for example, by segregation of the newly formed high melting esters from the reaction mixture through controlled crystallization during interesterification). Further information about interesterification is provided in Macrae, A., et al., “Enzymic Interesterification,” 2000 Society of Chemical Industry, SCI Lecture Papers Series, ISSN 1353-114X, LPS 117/2000, Minal, J., “An Introduction to Random Interesterification of Palm Oil,” Palm Oil Developments 39, pp. 1-6, and Kellens, M., “Interesterification: Process Conditions,” 2000 Society of Chemical Industry, SCI Lecture Papers Series, ISSN 1353-114X, LPS 114/2000, (all of which are incorporated by reference).

As part of one or more of the foregoing methods, the edible oil can be subjected to additional processing steps as appropriate. With respect to the seed blending steps, a method will generally include steps for refining, bleaching and deodorizing. The steps of oil blending, hydrogenation, and interesterification typically occur after refining and bleaching; after one or more of the oil blending steps, the oil can be deodorized. After deodorizing, a sufficient amount of one or more antioxidants can be added to the oil to achieve a desired oxidative stability index value, for example an oxidative stability index value comparable to typical frying shortening products.

In another aspect, the present invention relates to an edible oil having a linolenic acid content of from about 0.5% to about 6%. The edible oil may, if desired, be normalized and/or virtually trans free. As another aspect, the present invention relates to methods for making such edible oils. The edible oil can be prepared by one or more of the methods described in this disclosure, including by combinations of those methods.

A method for preparing an edible oil comprises blending a first edible oil (such as low linolenic edible oil) and a second edible oil (such as an edible oil having a higher linolenic acid content and/or a higher oleic acid content than the first edible oil). For example, the method can comprise blending a low linolenic soybean oil and an oil that is higher in linolenic acid and/or oleic acid or has other desired fatty acid contents. For example, the method can comprise blending a low linolenic soybean oil with a relatively high oleic vegetable oil, such as high oleic canola oil, extra virgin olive oil, high oleic safflower oil, very high oleic sunflower oil or a triolein. Suitable oils are blended in a ratio effective to produce a vegetable oil having an oleic acid content of about 27% or greater, alternatively about 40% or greater, and a linolenic acid content of about 4% or less. Oils can be blended subsequent to refining and bleaching and prior to deodorization. This aspect of the invention can be achieved by the blending of additional oils with refined and bleached oils, followed by deodorization.

Another method for preparing an edible oil comprises subjecting an edible oil to partial/brush hydrogenation to an extent sufficient to produce an edible oil having a desired fatty acid profile.

Another method for preparing an edible oil comprises subjecting an edible oil to hydrogenation as described in the Higgins publication to an extent sufficient to produce an edible oil having a desired fatty acid profile.

Any of the processing methods described herein can also include seed blending as a step. For example, seed obtained from growers can be blended prior to refining or crushing. Seed blending refers to blending seed from different sources or of different types. For example, canola seed having a relatively high oleic acid content (for example, from about 60% to about 80%, alternatively from greater than about 60% to less than about 80%, alternatively between about 65% and about 73%, alternatively between about 67% and about 71%) can be blended with low linolenic soybean seed having a relatively low linolenic acid content (for example about 6% or less, alternatively about 5% or less). Alternatively or additionally, one type of oil seed (for example, low linolenic soybean oil) can be blended with another type of oil seed (for example, corn, soybean, safflower, or sunflower).

The present methods can also include adding one or more antioxidants to an edible oil. For example, antioxidants for use in the present methods include natural tocopherols and commercially available synthetics. Antioxidants can include any substance that inhibits oxidation or reactions promoted by oxygen or peroxides and that is suitable for inclusion in a given product. For example, where the antioxidant is to be included in an edible oil, a suitable antioxidant should be suitable for consumption. Antioxidants include both natural and man-made antioxidants. Examples of natural antioxidants include, without limitation, the ascorbic acids (such as vitamin C, sodium ascorbate, calcium ascorbate, potassium ascorbate, ascorbyl palmitate, or any combination thereof; and the tocopherols (the vitamin E family, alpha tocopherol and other isomers of tocopherol). Examples of man-made antioxidants include, without limitation, the gallates (such as propyl gallate, octyl gallate); butylhydroxyanisol (BHA); butylhydroxytoluene (BHT); tert-butylhydroquinone (tBHQ); ethoxyquin; NDGA (4,4i (2,3 dimethyl tetramethylene dipyrochatechol)); or any mixed combination thereof. Antioxidants can be combined to take advantage of their differing properties. U.S. Pat. No. 4,232,122 (which is incorporated by reference herein) discusses antioxidants and antioxidant compositions useful as stabilizers for food compositions, including edible fats and oils. Further information about antioxidants is found in Ullah, J., et al., “Effect of light, natural and synthetic antioxidants on stability of edible oil and fats,” Asian Journal of Plant Sciences 2 (17-24):1192-1194, 2003 (which is incorporated by reference).

The present method of preparing an edible oil can include the steps of selecting a desired oxidative stability index, and adding an antioxidant to the edible oil if the linolenic acid content of the edible oil is more than about 4%. If the linolenic acid content of the edible oil is less than about 4%, the preparation method can comprise omitting added antioxidants from the edible oil.

The foregoing oil blending methods can comprise blending one or more of medium chain saturated fatty acid containing oils, long chain high oleic containing oils, and/or linolenic acid reduced oils.

Another feature of the present invention is the ability to use current minimally processed commodity oils to meet the market demand for virtually trans free frying shortenings. Benefits to food processors and the food service establishment include consistent quality and acceptable volume.

Yet another feature of the present invention is the ability to use online measurement protocols to adjust the linolenic content of a RB (refined and bleached) edible oil blend. This can be done to provide consistent linolenic acid content during the blending operation.

Persons skilled in the art can, using the preceding description, make and use the present edible oils and methods but the following examples are provided to further illustrate the present edible oils and methods. The following examples are not intended to limit the scope of the invention or the claims.

### EXAMPLE 1

Vegetable oil blends having desired contents of various fatty acids and other desired characteristics are prepared as follows from a low linolenic soybean oil and a canola oil having a relatively high linolenic acid content. A low linolenic soybean oil is provided which has the following fatty acid profile set forth in Table 1 (namely, 9.7% palmitic acid, 4.3% stearic acid, 25.3% oleic acid, 56.0% linolenic acid, and 2.8% linolenic acid, and no appreciable amounts of caprylic acid, capric acid, or lauric acid). Also a canola oil is provided which has the fatty acid profile set forth in Table 1. The low linolenic soybean oil and the canola oil are blended in varying percentages, as shown in Table 1, to form eight vegetable oil blends (Blends 1A through 1H). Table 1 also shows the content of various fatty acids in each of Blends 1A through 1H. One or more antioxidants can be added to any of Blends 1A through 1H, or to the low linolenic soybean oil and/or the canola oil used as starting materials. Preferably, one or more antioxidants are added to Blends 1D, 1E, 1F, 1G and/or 1H, and antioxidants are not added to Blends 1A, 1B and/or 1C, which remain substantially free of added antioxidants. Low linolenic soybean oils and/or canola oils (including conventional canola oils and high oleic canola oils) having different fatty acid profiles can be used in place of the starting materials used in this Example 1 to provide other blends.

### EXAMPLE 2

Vegetable oil blends having desired contents of various fatty acids and other desired characteristics are prepared as follows from a low linolenic soybean oil and a cottonseed oil. A low linolenic soybean oil is provided which has the fatty acid profile set forth in Table 2. A cottonseed oil is provided which has the fatty acid profile set forth in Table 2. The low linolenic soybean oil and the cottonseed oil are blended in varying percentages, as shown in Table 2, to form eight vegetable oil blends (Blends 2A through 2H). Table 2 also shows the content of various fatty acids in each of Blends 2A through 2H. One or more antioxidants can be added to any of Blends 2A through 2H. Preferably, antioxidants are not added to Blends 2A through 2H, which remain substantially free of added antioxidants. Low linolenic soybean oils and/or cottonseed oils having different fatty acid profiles can be used in place of the starting materials used in this Example 2 to provide other blends.

### EXAMPLE 3

Vegetable oil blends having desired contents of various fatty acids and other desired characteristics are prepared as follows from a low linolenic soybean oil and a high oleic safflower oil. A low linolenic soybean oil is provided which has the fatty acid profile set forth in Table 3. A high oleic safflower oil is provided which has the fatty acid profile set forth in Table 3. The low linolenic soybean oil and the high oleic safflower oil are blended in varying percentages, as shown in Table 3, to form eight vegetable oil blends (Blends 3A through 3H). Table 3 also shows the content of various fatty acids in each of Blends 3A through 3H. One or more antioxidants can be added to any of Blends 3A through 3H. Preferably, antioxidants are not added to Blends 3A through 3H, which remain substantially free of added antioxidants. Low linolenic soybean oils and/or high oleic safflower oils having different fatty acid profiles can be used in place of the starting materials used in this Example 3 to provide other blends.

### EXAMPLE 4

Vegetable oil blends having desired contents of various fatty acids and other desired characteristics are prepared as follows from a low linolenic soybean oil and a soybean oil. A low linolenic soybean oil is provided which has the fatty acid profile set forth in Table 4. A soybean oil is provided which has the fatty acid profile set forth in Table 4. The low linolenic soybean oil and the soybean oil are blended in varying percentages, as shown in Table 4, to form eight vegetable oil blends (Blends 4A through 4H). Table 4 also shows the content of various fatty acids in each of Blends 4A through 4H. One or more antioxidants can be added to any of Blends 4A through 4H. Preferably, one or more antioxidants are added to Blends 4F, 4G and/or 4H, and antioxidants are not added to Blends 4A, 4B, 4C and/or 4D, which remain substantially free of added antioxidants. Low linolenic soybean oils and/or soybean oils having different fatty acid profiles can be used in place of the starting materials used in this Example 4 to provide other blends.

### EXAMPLE 5

Vegetable oil blends having desired contents of various fatty acids and other desired characteristics are prepared as follows from a low linolenic soybean oil and an extra virgin olive oil. A low linolenic soybean oil is provided which has the fatty acid profile set forth in Table 5. An olive oil is provided which has the fatty acid profile set forth in Table 5. The low linolenic soybean oil and the extra virgin olive oil are blended in varying percentages, as shown in Table 5, to form eight vegetable oil blends (Blends 5A through 5H). Table 5 also shows the content of various fatty acids in each of Blends 5A through 5H. One or more antioxidants can be added to any of Blends 5A through 5H. Preferably, antioxidants are not added to Blends 5A through 5H, which remain substantially free of added antioxidants. Low linolenic soybean oils and/or olive oils (including virgin olive oils and extra virgin olive oils) having different fatty acid profiles can be used in place of the starting materials used in this Example 5 to provide other blends.

### EXAMPLE 6

Vegetable oil blends having desired contents of various fatty acids and other desired characteristics are prepared as follows from a low linolenic soybean oil and high oleic canola oil. A low linolenic soybean oil is provided which has the fatty acid profile set forth in Table 6. A high oleic canola oil is provided which has the fatty acid profile set forth in Table 6. The low linolenic soybean oil and the high oleic canola oil are blended in varying percentages, as shown in Table 6, to form eight vegetable oil blends (Blends 6A through 6H). Table 6 also shows the content of various fatty acids in each of Blends 6A through 6H. Low linolenic soybean oils and/or high oleic canola oils having different fatty acid profiles can be used in place of the starting materials used in this Example 6 to provide other blends.

### EXAMPLE 7

Vegetable oil blends having desired contents of various fatty acids and other desired characteristics are prepared as follows from a low linolenic soybean oil and a very high oleic sunflower oil. A low linolenic soybean oil is provided which has the fatty acid profile set forth in Table 7. A very high oleic sunflower oil is provided which has the fatty acid profile set forth in Table 7. The low linolenic soybean oil and the very high oleic sunflower oil are blended in varying percentages, as shown in Table 7, to form eight vegetable oil blends (Blends 7A through 7H). Table 7 also shows the content of various fatty acids in each of Blends 7A through 7H. Low linolenic soybean oils and/or very high oleic sunflower oils having different fatty acid profiles can be used in place of the starting materials used in this Example 7 to provide other blends.

### EXAMPLE 8

Vegetable oil blends having desired contents of various fatty acids and other desired characteristics are prepared as follows from a low linolenic soybean oil and a palm oil (olein fraction). A low linolenic soybean oil is provided which has the fatty acid profile set forth in Table 8. A palm oil (olein fraction) is provided which has the fatty acid profile set forth in Table 8. The low linolenic soybean oil and the palm oil (olein fraction) are blended in varying percentages, as shown in Table 8, to form eight vegetable oil blends (Blends 8A through 8H). Table 8 also shows the content of various fatty acids in each of Blends 8A through 8H. Alternatively or additionally, one or more of the starting materials and/or resulting blends are processed by interesterification as described above. Low linolenic soybean oils and/or palm oils (olein fraction) having different fatty acid profiles can be used in place of the starting materials used in this Example 8 to provide other blends.

### EXAMPLE 9

Edible oil blends having desired contents of various fatty acids and other desired characteristics are prepared as follows from a low linolenic soybean oil and medium-chain triglyceride (MCT) oil, such as Neobee® 1053. A low linolenic soybean oil is provided which has the fatty acid profile set forth in Table 9. An MCT oil is provided which has the fatty acid profile set forth in Table 9. The low linolenic soybean oil and the MCT oil are blended in varying percentages, as shown in Table 9, to form eight edible oil blends (Blends 9A through 9H). Table 9 also shows the content of various fatty acids in each of Blends 9A through 9H. One or more antioxidants can be added to any of Blends 9A through 9H. Preferably, antioxidants are not added to Blends 9A through 9H, which remain substantially free of added antioxidants. Alternatively or additionally, one or more of the starting materials and/or resulting blends (preferably Blends 9A, 9B, 9C, and/or 9D) are processed by interesterification as described above. Low linolenic soybean oils and/or MCT oils having different fatty acid profiles can be used in place of the starting materials used in this Example 9 to provide other blends.

### EXAMPLE 10

Vegetable oil blends having desired contents of various fatty acids and other desired characteristics are prepared as follows from a low linolenic soybean oil and a partially hydrogenated soybean oil having a reduced trans fat content, such as HI-LITE High Stability Oil available from Bunge Oils, and/or an oil prepared according to the teachings of U.S. Patent Application Publication No. 2004/0146626 A1 (Higgins). A low linolenic soybean oil is provided which has the fatty acid profile set forth in Table 10. A reduced trans fat, partially hydrogenated soybean oil is provided which has the fatty acid profile set forth in Table 10. The low linolenic soybean oil and the reduced trans fat, partially hydrogenated soybean oil are blended in varying percentages, as shown in Table 10, to form eight vegetable oil blends (Blends 10A through 10H). Table 10 also shows the content of various fatty acids in each of Blends 10A through 10H. One or more of the starting materials and/or resulting blends can be processed by hydrogenation as described in the Higgins publication. Low linolenic soybean oils and/or reduced trans fat, partially hydrogenated soybean oils having different fatty acid profiles can be used in place of the starting materials used in this Example 10 to provide other blends.

### EXAMPLE 11

Vegetable oil blends having desired contents of various fatty acids and other desired characteristics are prepared as follows from a low linolenic soybean oil and another partially hydrogenated soybean oil. A low linolenic soybean oil is provided which has the fatty acid profile set forth in Table 11. A partially hydrogenated soybean oil is provided which has the fatty acid profile set forth in Table 11. The low linolenic soybean oil and the partially hydrogenated soybean oil are blended in varying percentages, as shown in Table 11, to form eight vegetable oil blends (Blends 11A through 11H). Table 11 also shows the content of various fatty acids in each of Blends 11A through 11H. One or more of the starting materials and/or resulting blends can be processed by brush hydrogenation. Low linolenic soybean oils and/or partially hydrogenated soybean oils having different fatty acid profiles can be used in place of the starting materials used in this Example 11 to provide other blends.

### EXAMPLE 12

Edible oil blends having desired contents of various fatty acids and other desired characteristics are prepared as follows from a low linolenic soybean oil and a triolein (a triglyceride having three oleic acids). A low linolenic soybean oil is provided which has the fatty acid profile set forth in Table 12. A triolein is provided which has the fatty acid profile set forth in Table 12. The low linolenic soybean oil and the triolein are blended in varying percentages, as shown in Table 12, to form eight edible oil blends (Blends 12A through 12H). Table 12 also shows the content of various fatty acids in each of Blends 12A through 12H. One or more antioxidants can be added to any of Blends 12A through 12H. Preferably, antioxidants are not added to Blends 12A through 12H, which remain substantially free of added antioxidants. Alternatively or additionally, one or more of the starting materials and/or resulting blends (preferably Blends 12A, 12B, 12C, and/or 12D) are processed by interesterification. Low linolenic soybean oils and/or trioleins having different fatty acid profiles can be used in place of the starting materials used in this Example 12 to provide other blends.

### EXAMPLE 13

Vegetable oil blends having desired contents of various fatty acids and other desired characteristics are prepared as follows from a low linolenic soybean oil and a corn oil. A low linolenic soybean oil is provided which has the fatty acid profile set forth in Table 13. A corn oil is provided which has the fatty acid profile set forth in Table 13. The low linolenic soybean oil and the corn oil are blended in varying percentages, as shown in Table 13, to form eight vegetable oil blends (Blends 13A through 13H). Each of the blends comprises 40% or less corn oil and 60% or more low linolenic soybean oil. Table 13 also shows the content of various fatty acids in each of Blends 13A through 13H. One or more antioxidants can be added to any of Blends 13A through 13H. Preferably, antioxidants are not added to Blends 13A through 13H, which remain substantially free of added antioxidants. Low linolenic soybean oils and/or corn oils having different fatty acid profiles can be used in place of the starting materials used in this Example 13 to provide other blends.

### EXAMPLE 14

Edible oil blends were prepared for comparison to a commercially available partially hydrogenated oil in fry life testing. Edible Oil Blend 14A comprised 45% low linolenic soybean oil, 45% high oleic canola oil, and 10% palm stearin. Edible Oil Blend 14B comprised 92% low linolenic soybean oil and 8% palm stearin. Edible oil blends 14A and 14B are non-hydrogenated oils and are virtually trans free. Edible oil blends 14A and 14B included 0.095% tert-butylhydroquinone (TBHQ) and 0.0006% dimethylpolysiloxane (DMPS). The edible oil blends were tested for fry life performance as follows, in comparison with a commercially available partially hydrogenated soybean oil (ELITE® POUR 'N FRY® Liquid Shortening from Bunge Oils). The commercial partially hydrogenated soybean oil included the same percentages of TBHQ and DMPS.

For each oil to be tested, seven and one-half pounds of the oils were placed in a properly cleaned Sodir (10.lb. capacity) fryer. A thermometer probe was inserted and a temperature recorder chart was started. The oil was heated to 385° F. ±15° F. (fryer should cycle between 370° F. & 400° F.). This temperature was maintained for 8 hours/day. After 8 hours, the fryer was shut off via circuit breaker. After the oil cooled, 3 ounces of oil was removed and put into a labeled, glass jar. The oil was stored at 40° F. The fryer was covered loosely (to allow heat to escape) until following morning. This procedure was repeated for a total of 5 days.

After all oil samples had been collected (including a control, unheated sample), the oil samples were analyzed for the following fry life properties: p-anisidine value (AV), Oxidative Stability Index (OSI), content of inter-polymerized triacylglycerols (Polymer), color, and dielectric constants. The control samples were also submitted for IV, FAME and FFA. P-anisidine values were determined using the following method: 1 g of oil (±0.1 g) is placed in a 25 ml volumetric flask. The oil is diluted with a solvent (iso-octane or hexane). The absorbance of the oil solution at 350 nm is measured using a Perkin Elmer Lambda 2 spectrophotometer, though equivalent instruments may be used, using solvent as a blank to determine absorbance of the unreacted sample (Au). Then 5 ml of the oil solution is pipetted into a test tube. 1 ml of purified para-anisidine reagent (which is prepared from 0.25 g purified p-anisidine diluted to 100 ml with glacial acetic acid) is added to the test tube. The test tube is capped and shaken. After 10 minutes, absorbance was measured to determine absorbance of the reacted sample (Ar). The p-anisidine value (AV) of the oil sample is calculated as 25 (1.2 Ar—Au)/wt(g) where wt is the weight of the sample in grams. OSI was found using AOCS Official Method Cd 12b-92. Polymer content was found using a variation of AOCS Official Method Cd 22-91 in which a different detector is used, namely a Sedex 55 Evaporative Light Scattering Detector. Color values (yellow and red) were measured using a Gardner Colorimeter on the 1″ Lovibond Color Scale. Dielectric constants (FOS) were measured using a FOODOIL SENSOR from Northern Technologies International Corp. (Lino Lakes, Minn.). The dielectric constants were found by using FOODOIL SENSOR according to the manufacturer's instructions.

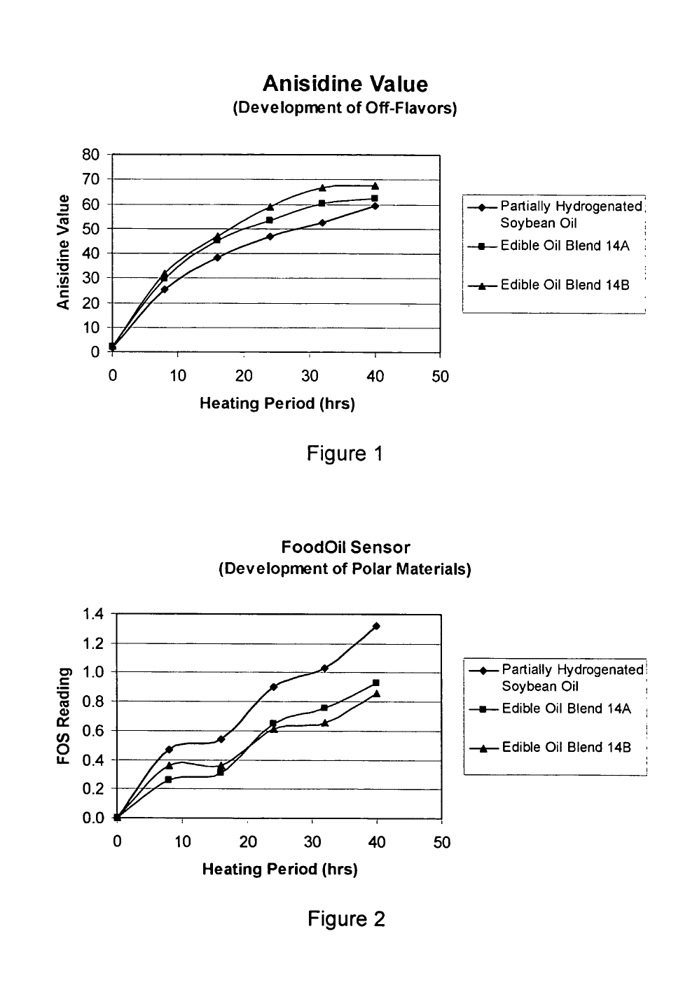

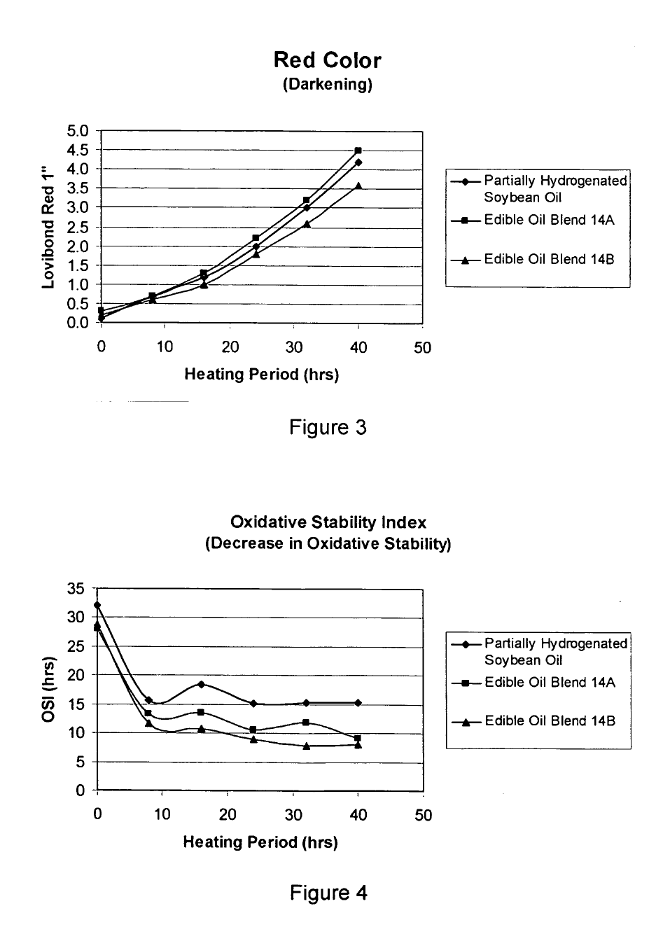

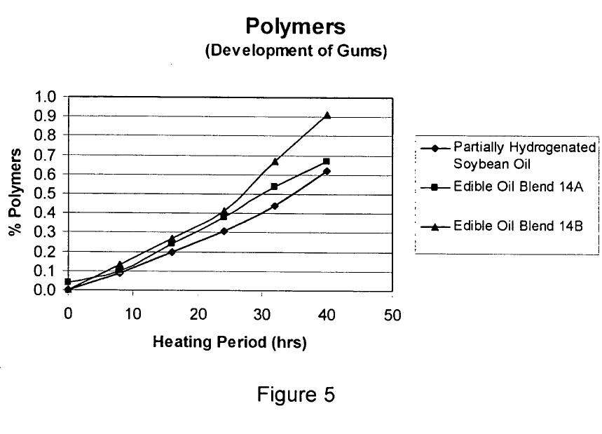

The results of the fry life testing of Edible Oil Blends 14A and B and the commercial hydrogenated soybean oil are shown in Table 14 and in FIGS. 1 to 5. Edible oil blends 14A and 14B had fry life performance comparable to the commercial partially hydrogenated soybean oil. It is contemplated that these edible oil blends would be commercially competitive with those commercially available oils, particularly since the edible oil blends are virtually trans free.

### EXAMPLE 15

Edible oil blends are prepared and evaluated for use as frying and griddle shortenings for food service. Blends are prepared which contained the following percentages of vegetable oils: (1) 88-92% low linolenic soybean oil, and 8-12% palm stearin; (2) 44-46% low linolenic soybean oil, 44-46% high oleic canola oil, and 8-12% palm stearin; (3) 50% low linolenic soybean oil and 50% corn oil. Blending the low linolenic soybean oil with other oils yields an edible oil blend having a lower linolenic acid content than the low linolenic soybean oil. Each of these blends has an enhanced fry life compared to the low linolenic soybean oil. The enhanced fry life is attributed to the lower linolenic acid content.

In the present specification, use of the singular includes the plural except where specifically indicated. In the present specification, any steps of the foregoing methods can be combined with one or more steps from other methods, to the extent they are compatible, to provide a written description for additional methods.

All patents, test procedures, and other documents cited herein are fully incorporated by reference to the extent such disclosure is not inconsistent with this invention and for all jurisdictions in which such incorporation is permitted.

While the present invention has been described and illustrated by reference to particular embodiments, it will be appreciated by those of ordinary skill in the art that the invention lends itself to many different variations not illustrated herein. For these reasons, then, reference should be made solely to the appended claims for purposes of determining the true scope of the present invention.

Although the dependent claims have single dependencies in accordance with U.S. patent practice, each of the features in any of the dependent claims can be combined with each of the features of other dependent claims or the main claim.

TABLE 1
Blends of Low Linolenic Soybean Oil and Canola Oil

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Canola Oil | | — | — | — | 4.1 | 1.9 | 60.1 | 21.2 | 9.2 |
| Percentage of Starting Materials in Blends: | | 1A | 1B | 1C | 1D | 1E | 1F | 1G | 1H |
| Low Linolenic Soybean Oil | | 95% | 90% | 85% | 80% | 75% | 70% | 65% | 60% |
| Canola Oil | | 5% | 10% | 15% | 20% | 25% | 30% | 35% | 40% |
| Fatty Acid Content of Blends: | | 1A | 1B | 1C | 1D | 1E | 1F | 1G | 1H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 9.4 | 9.1 | 8.9 | 8.6 | 8.3 | 8.0 | 7.7 | 7.5 |
| Stearic Acid | C18:0 | 4.2 | 4.1 | 3.9 | 3.8 | 3.7 | 3.6 | 3.5 | 3.3 |
| Oleic Acid | C18:1 | 27.0 | 28.8 | 30.5 | 32.3 | 34.0 | 35.7 | 37.5 | 39.2 |
| Linoleic Acid | C18:2 | 54.3 | 52.5 | 50.8 | 49.0 | 47.3 | 45.6 | 43.8 | 42.1 |
| Linolenic Acid | C18:3 | 3.1 | 3.4 | 3.8 | 4.1 | 4.4 | 4.7 | 5.0 | 5.4 |

| | | | | | | | | |
|---|---|---|---|---|---|---|---|---|
| SATURATED FATTY ACID CONTENT: | 13.6 | 13.2 | 12.8 | 12.4 | 12.0 | 11.6 | 11.2 | 10.8 |
| POLYUNSATURATES CONTENT: | 57.4 | 56.0 | 54.5 | 53.1 | 51.7 | 50.3 | 48.9 | 47.4 |

TABLE 2
Blends of Low Linolenic Soybean Oil and Cottonseed Oil

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Cottonseed Oil | | — | — | — | 23.7 | 2.3 | 17.6 | 53.8 | 0.3 |
| Percentage of Starting Materials in Blends: | | 2A | 2B | 2C | 2D | 2E | 2F | 2G | 2H |
| Low Linolenic Soybean Oil | | 95% | 90% | 85% | 80% | 75% | 70% | 65% | 60% |
| Cottonseed Oil | | 5% | 10% | 15% | 20% | 25% | 30% | 35% | 40% |
| Fatty Acid Content of Blends: | | 2A | 2B | 2C | 2D | 2E | 2F | 2G | 2H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 10.4 | 11.1 | 11.8 | 12.5 | 13.2 | 13.9 | 14.6 | 15.3 |
| Stearic Acid | C18:0 | 4.2 | 4.1 | 4.0 | 3.9 | 3.8 | 3.7 | 3.6 | 3.5 |
| Oleic Acid | C18:1 | 24.9 | 24.5 | 24.1 | 23.8 | 23.4 | 23.0 | 22.6 | 22.2 |
| Linoleic Acid | C18:2 | 55.9 | 55.8 | 55.7 | 55.6 | 55.5 | 55.3 | 55.2 | 55.1 |
| Linolenic Acid | C18:3 | 2.7 | 2.6 | 2.4 | 2.3 | 2.2 | 2.1 | 1.9 | 1.8 |

| | | | | | | | | |
|---|---|---|---|---|---|---|---|---|
| SATURATED FATTY ACID CONTENT: | 14.6 | 15.2 | 15.8 | 16.4 | 17.0 | 17.6 | 18.2 | 18.8 |
| POLYUNSATURATES CONTENT: | 58.6 | 58.3 | 58.1 | 57.9 | 57.6 | 57.4 | 57.2 | 56.9 |

TABLE 3
Blends of Low Linolenic Soybean Oil and High Oleic Safflower Oil

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| High Oleic Safflower Oil | | — | — | — | 4.8 | 1.9 | 77.6 | 14.6 | — |
| Percentage of Starting Materials in Blends: | | 3A | 3B | 3C | 3D | 3E | 3F | 3G | 3H |
| Low Linolenic Soybean Oil | | 95% | 90% | 85% | 80% | 75% | 70% | 65% | 60% |
| High Oleic Safflower Oil | | 5% | 10% | 15% | 20% | 25% | 30% | 35% | 40% |
| Fatty Acid Content of Blends: | | 3A | 3B | 3C | 3D | 3E | 3F | 3G | 3H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 9.5 | 9.2 | 9.0 | 8.7 | 8.5 | 8.2 | 8.0 | 7.7 |
| Stearic Acid | C18:0 | 4.2 | 4.1 | 3.9 | 3.8 | 3.7 | 3.6 | 3.5 | 3.3 |
| Oleic Acid | C18:1 | 27.9 | 30.5 | 33.1 | 35.8 | 38.4 | 41.0 | 43.6 | 46.2 |
| Linoleic Acid | C18:2 | 53.9 | 51.9 | 49.8 | 47.7 | 45.7 | 43.6 | 41.5 | 39.4 |
| Linolenic Acid | C18:3 | 2.7 | 2.5 | 2.4 | 2.2 | 2.1 | 2.0 | 1.8 | 1.7 |

| | | | | | | | | |
|---|---|---|---|---|---|---|---|---|
| SATURATED FATTY ACID CONTENT: | 13.6 | 13.3 | 12.9 | 12.5 | 12.2 | 11.8 | 11.4 | 11.1 |
| POLYUNSATURATES CONTENT: | 56.6 | 54.4 | 52.2 | 50.0 | 47.8 | 45.5 | 43.3 | 41.1 |

TABLE 4
Blends of Low Linolenic Soybean Oil and Soybean Oil (w/antioxidants)

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Soybean Oil | | — | — | — | 10.5 | 3.9 | 22.4 | 54.5 | 7.7 |
| Percentage of Starting Materials in Blends: | | 4A | 4B | 4C | 4D | 4E | 4F | 4G | 4H |
| Low Linolenic Soybean Oil | | 95% | 90% | 85% | 80% | 75% | 70% | 65% | 60% |
| Soybean Oil | | 5% | 10% | 15% | 20% | 25% | 30% | 35% | 40% |
| Fatty Acid Content of Blends: | | 4A | 4B | 4C | 4D | 4E | 4F | 4G | 4H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 9.7 | 9.8 | 9.8 | 9.9 | 9.9 | 9.9 | 10.0 | 10.0 |
| Stearic Acid | C18:0 | 4.3 | 4.3 | 4.2 | 4.2 | 4.2 | 4.2 | 4.2 | 4.1 |
| Oleic Acid | C18:1 | 25.2 | 25.0 | 24.9 | 24.7 | 24.6 | 24.4 | 24.3 | 24.1 |
| Linoleic Acid | C18:2 | 55.9 | 55.9 | 55.8 | 55.7 | 55.6 | 55.6 | 55.5 | 55.4 |
| Linolenic Acid | C18:3 | 3.0 | 3.3 | 3.5 | 3.8 | 4.0 | 4.3 | 4.5 | 4.8 |

| | | | | | | | | |
|---|---|---|---|---|---|---|---|---|
| SATURATED FATTY ACID CONTENT: | 14.0 | 14.0 | 14.1 | 14.1 | 14.1 | 14.1 | 14.1 | 14.2 |
| POLYUNSATURATES CONTENT: | 59.0 | 59.1 | 59.3 | 59.5 | 59.7 | 59.8 | 60.0 | 60.2 |

TABLE 5
Blends of Low Linolenic Soybean Oil and Olive Oil

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Olive Oil (Virgin) | | — | — | — | 9.0 | 2.7 | 80.3 | 6.3 | 0.7 |
| Percentage of Starting Materials in Blends: | | 5A | 5B | 5C | 5D | 5E | 5F | 5G | 5H |
| Low Linolenic Soybean Oil | | 60% | 55% | 50% | 45% | 40% | 35% | 30% | 25% |
| Olive Oil | | 40% | 45% | 50% | 55% | 60% | 65% | 70% | 75% |
| Fatty Acid Content of Blends: | | 5A | 5B | 5C | 5D | 5E | 5F | 5G | 5H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 9.4 | 9.4 | 9.4 | 9.3 | 9.3 | 9.2 | 9.2 | 9.2 |
| Stearic Acid | C18:0 | 3.7 | 3.6 | 3.5 | 3.4 | 3.3 | 3.3 | 3.2 | 3.1 |
| Oleic Acid | C18:1 | 47.3 | 50.1 | 52.8 | 55.6 | 58.3 | 61.1 | 63.8 | 66.6 |
| Linoleic Acid | C18:2 | 36.1 | 33.6 | 31.2 | 28.7 | 26.2 | 23.7 | 21.2 | 18.7 |
| Linolenic Acid | C18:3 | 2.0 | 1.9 | 1.8 | 1.6 | 1.5 | 1.4 | 1.3 | 1.2 |

| | | | | | | | | |
|---|---|---|---|---|---|---|---|---|
| SATURATED FATTY ACID CONTENT: | 13.1 | 13.0 | 12.9 | 12.7 | 12.6 | 12.5 | 12.4 | 12.3 |
| POLYUNSATURATES CONTENT: | 38.1 | 35.5 | 32.9 | 30.3 | 27.7 | 25.1 | 22.5 | 20.0 |

TABLE 6
Blends of Low Linolenic Soybean Oil and High Oleic Canola Oil

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| High Oleic Canola Oil | | — | — | — | 3.6 | 1.6 | 69.0 | 19.4 | 3.7 |
| Percentage of Starting Materials in Blends: | | 6A | 6B | 6C | 6D | 6E | 6F | 6G | 6H |
| Low Linolenic Soybean Oil | | 60% | 55% | 50% | 45% | 40% | 35% | 30% | 25% |
| High Oleic-Canola Oil | | 40% | 45% | 50% | 55% | 60% | 65% | 70% | 75% |
| Fatty Acid Content of Blends: | | 6A | 6B | 6C | 6D | 6E | 6F | 6G | 6H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 7.3 | 7.0 | 6.7 | 6.3 | 6.0 | 5.7 | 5.4 | 5.1 |
| Stearic Acid | C18:0 | 3.2 | 3.1 | 3.0 | 2.8 | 2.7 | 2.5 | 2.4 | 2.3 |
| Oleic Acid | C18:1 | 42.8 | 45.0 | 47.2 | 49.3 | 51.5 | 53.7 | 55.9 | 58.1 |
| Linoleic Acid | C18:2 | 41.4 | 39.5 | 37.7 | 35.9 | 34.0 | 32.2 | 30.4 | 28.6 |
| Linolenic Acid | C18:3 | 3.2 | 3.2 | 3.3 | 3.3 | 3.3 | 3.4 | 3.4 | 3.5 |

| | | | | | | | | |
|---|---|---|---|---|---|---|---|---|
| SATURATED FATTY ACID CONTENT: | 10.5 | 10.0 | 9.6 | 9.2 | 8.7 | 8.3 | 7.8 | 7.4 |
| POLYUNSATURATES CONTENT: | 44.5 | 42.7 | 41.0 | 39.2 | 37.4 | 35.6 | 33.8 | 32.0 |

TABLE 7
Blends of Low Linolenic Soybean Oil and Very High Oleic Sunflower Oil

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Very High Oleic Sunflower Oil | | — | — | — | 2.7 | 3.7 | 86.8 | 4.7 | 0.2 |
| Percentage of Starting Materials in Blends: | | 7A | 7B | 7C | 7D | 7E | 7F | 7G | 7H |
| Low Linolenic Soybean Oil | | 65% | 60% | 55% | 50% | 45% | 40% | 35% | 30% |
| VHO Sunflower Oil | | 35% | 40% | 45% | 50% | 55% | 60% | 65% | 70% |
| Fatty Acid Content of Blends: | | 7A | 7B | 7C | 7D | 7E | 7F | 7G | 7H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 7.3 | 6.9 | 6.6 | 6.2 | 5.9 | 5.5 | 5.2 | 4.8 |
| Stearic Acid | C18:0 | 4.1 | 4.1 | 4.0 | 4.0 | 4.0 | 3.9 | 3.9 | 3.9 |
| Oleic Acid | C18:1 | 46.8 | 49.9 | 53.0 | 56.1 | 59.1 | 62.2 | 65.3 | 68.4 |
| Linoleic Acid | C18:2 | 38.0 | 35.5 | 32.9 | 30.4 | 27.8 | 25.2 | 22.7 | 20.1 |
| Linolenic Acid | C18:3 | 1.9 | 1.8 | 1.6 | 1.5 | 1.4 | 1.2 | 1.1 | 1.0 |

| | | | | | | | | |
|---|---|---|---|---|---|---|---|---|
| SATURATED FATTY ACID CONTENT: | 11.3 | 11.0 | 10.6 | 10.2 | 9.8 | 9.4 | 9.1 | 8.7 |
| POLYUNSATURATES CONTENT: | 39.9 | 37.2 | 34.5 | 31.9 | 29.2 | 26.5 | 23.8 | 21.1 |

TABLE 8
Blends of Low Linolenic Soybean Oil and Palm Oil (Olein Fraction)

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Palm Oil (Olein Fraction) | | — | — | 0.4 | 40.2 | 4.0 | 42.1 | 10.9 | 0.3 |
| Percentage of Starting Materials in Blends: | | 8A | 8B | 8C | 8D | 8E | 8F | 8G | 8H |
| Low Linolenic Soybean Oil | | 50% | 45% | 40% | 35% | 30% | 25% | 20% | 15% |
| Palm Oil (Olein Fraction) | | 50% | 55% | 60% | 65% | 70% | 75% | 80% | 85% |
| Fatty Acid Content of Blends: | | 8A | 8B | 8C | 8D | 8E | 8F | 8G | 8H |
| Caprylic Acid | C8:0 | — | — | — | — | — | — | — | — |
| Capric Acid | C10:0 | — | — | — | — | — | — | — | — |
| Lauric Acid | C12:0 | 0.20 | 0.22 | 0.24 | 0.26 | 0.28 | 0.30 | 0.32 | 0.34 |
| Palmitic Acid | C16:0 | 25.0 | 26.5 | 28.0 | 29.5 | 31.1 | 32.6 | 34.1 | 35.6 |
| Stearic Acid | C18:0 | 4.2 | 4.1 | 4.1 | 4.1 | 4.1 | 4.1 | 4.1 | 4.0 |
| Oleic Acid | C18:1 | 33.7 | 34.5 | 35.4 | 36.2 | 37.1 | 37.9 | 38.7 | 39.6 |
| Linoleic Acid | C18:2 | 33.5 | 31.2 | 28.9 | 26.7 | 24.4 | 22.2 | 19.9 | 17.7 |
| Linolenic Acid | C18:3 | 1.6 | 1.4 | 1.3 | 1.2 | 1.1 | 0.9 | 0.8 | 0.7 |

| | | | | | | | | |
|---|---|---|---|---|---|---|---|---|
| SATURATED FATTY ACID CONTENT: | 29.3 | 30.8 | 32.4 | 33.9 | 35.4 | 37.0 | 38.5 | 40.0 |
| POLYUNSATURATES CONTENT: | 35.0 | 32.6 | 30.2 | 27.9 | 25.5 | 23.1 | 20.7 | 18.3 |

TABLE 9
Blends of Low Linolenic Soybean Oil and MCT Oil (Neobee 1053)

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| MCT Oil (Neobee 1053) | | 52.0 | 46.5 | 1.5 | — | — | — | — | — |
| Percentage of Starting Materials in Blends: | | 9A | 9B | 9C | 9D | 9E | 9F | 9G | 9H |
| Low Linolenic Soybean Oil | | 95% | 90% | 85% | 80% | 75% | 70% | 65% | 60% |
| MCT Oil | | 5% | 10% | 15% | 20% | 25% | 30% | 35% | 40% |
| Fatty Acid Content of Blends: | | 9A | 9B | 9C | 9D | 9E | 9F | 9G | 9H |
| Caprylic Acid | C8:0 | 2.60 | 5.20 | 7.80 | 10.40 | 13.00 | 15.60 | 18.20 | 20.80 |
| Capric Acid | C10:0 | 2.33 | 4.65 | 6.98 | 9.30 | 11.63 | 13.95 | 16.28 | 18.60 |
| Lauric Acid | C12:0 | 0.08 | 0.15 | 0.23 | 0.30 | 0.38 | 0.45 | 0.53 | 0.60 |
| Palmitic Acid | C16:0 | 9.2 | 8.7 | 8.2 | 7.8 | 7.3 | 6.8 | 6.3 | 5.8 |
| Stearic Acid | C18:0 | 4.1 | 3.9 | 3.7 | 3.4 | 3.2 | 3.0 | 2.8 | 2.6 |
| Oleic Acid | C18:1 | 24.0 | 22.8 | 21.5 | 20.2 | 19.0 | 17.7 | 16.4 | 15.2 |
| Linoleic Acid | C18:2 | 53.2 | 50.4 | 47.6 | 44.8 | 42.0 | 39.2 | 36.4 | 33.6 |
| Linolenic Acid | C18:3 | 2.7 | 2.5 | 2.4 | 2.2 | 2.1 | 2.0 | 1.8 | 1.7 |

| | | | | | | | | |
|---|---|---|---|---|---|---|---|---|
| SATURATED FATTY ACID CONTENT: | 18.3 | 22.6 | 26.9 | 31.2 | 35.5 | 39.8 | 44.1 | 48.4 |
| POLYUNSATURATES CONTENT: | 55.9 | 52.9 | 50.0 | 47.0 | 44.1 | 41.2 | 38.2 | 35.3 |

TABLE 10
Blends of Low Linolenic Soybean Oil and Part. Hyd. Soy (rt. base)

| Fatty Acid Content of Starting Materials: | | C8:0 | C10:0 | C12:0 | C16:0 | C18:0 | C18:1 | C18:2 | C18:3 |
|---|---|---|---|---|---|---|---|---|---|
| Low Linolenic Soybean Oil | | — | — | — | 9.7 | 4.3 | 25.3 | 56.0 | 2.8 |
| Part. Hyd. Soy (rt. base) | | — | — | — | 12.0 | 16.5 | 24.5 | 40.1 | 5.4 |
| Percentage of Starting Materials in Blends: | | 10A | 10B | 10C | 10D | 10E | 10F | 10G | 10H |
| Low Linolenic Soybean Oil | | 95% | 90% | 85% | 80% | 75% | 70% | 65% | 60% |
| PHS (rt. base) Oil | | 5% | 10% | 15% | 20% | 25% | 30% | 35% | 40% |
| Fatty Acid Content of Blends: | | 10A | 10B | 10C | 10D | 10E | 10F | 10G | 10H |
| Caprylic Acid | C8:0 | — | — | — | — | — | — | — | — |
| Capric Acid | C10:0 | — | — | — | — | — | — | — | — |
| Lauric Acid | C12:0 | — | — | — | — | — | — | — | — |
| Palmitic Acid | C16:0 | 9.8 | 9.9 | 10.0 | 10.2 | 10.3 | 10.4 | 10.5 | 10.6 |
| Stearic Acid | C18:0 | 4.9 | 5.5 | 6.1 | 6.7 | 7.4 | 8.0 | 8.6 | 9.2 |
| Oleic Acid | C18:1 | 25.3 | 25.2 | 25.2 | 25.1 | 25.1 | 25.1 | 25.0 | 25.0 |
| Linoleic Acid | C18:2 | 55.2 | 54.4 | 53.6 | 52.8 | 52.0 | 51.2 | 50.4 | 49.6 |
| Linolenic Acid | C18:3 | 2.9 | 3.1 | 3.2 | 3.3 | 3.5 | 3.6 | 3.7 | 3.8 |

| | | | | | | | | |
|---|---|---|---|---|---|---|---|---|
| SATURATED FATTY ACID CONTENT: | 14.7 | 15.5 | 16.2 | 16.9 | 17.6 | 18.4 | 19.1 | 19.8 |
| POLYUNSATURATES CONTENT: | 58.1 | 57.5 | 56.8 | 56.1 | 55.5 | 54.8 | 54.2 | 53.5 |

TABLE 11
Blends of Low Linolenic Soybean Oil and Part. Hyd. Soy (hi-lite base)

| Fatty Acid Content of Starting Materials: | C8:0 | C10:0 | C12:0 | C16:0 | C18:0 | C18:1 | C18:2 | C18:3 |
|---|---|---|---|---|---|---|---|---|
| Low Linolenic Soybean Oil | — | — | — | 9.7 | 4.3 | 25.3 | 56.0 | 2.8 |
| Part. Hyd. Soy (hi-lite base) | — | — | — | 10.0 | 5.5 | 55.6 | 25.9 | 1.2 |
| Percentage of Starting Materials in Blends: | 11A | 11B | 11C | 11D | 11E | 11F | G11 | 11H |
| Low Linolenic Soybean Oil | 95% | 90% | 85% | 80% | 75% | 70% | 65% | 60% |
| PHS (hi-lite base) Oil | 5% | 10% | 15% | 20% | 25% | 30% | 35% | 40% |
| Fatty Acid Content of Blends: | 11A | 11B | 11C | 11D | 11E | 11F | 11G | 11H |
| Caprylic Acid C8:0 | — | — | — | — | — | — | — | — |
| Capric Acid C10:0 | — | — | — | — | — | — | — | — |
| Lauric Acid C12:0 | — | — | — | — | — | — | — | — |
| Palmitic Acid C16:0 | 9.7 | 9.7 | 9.7 | 9.8 | 9.8 | 9.8 | 9.8 | 9.8 |
| Stearic Acid C18:0 | 4.4 | 4.4 | 4.5 | 4.5 | 4.6 | 4.7 | 4.7 | 4.8 |
| Oleic Acid C18:1 | 26.8 | 28.3 | 29.8 | 31.4 | 32.9 | 34.4 | 35.9 | 37.4 |
| Linoleic Acid C18:2 | 54.5 | 53.0 | 51.5 | 50.0 | 48.5 | 47.0 | 45.5 | 44.0 |
| Linolenic Acid C18:3 | 2.7 | 2.6 | 2.6 | 2.5 | 2.4 | 2.3 | 2.2 | 2.2 |
| SATURATED FATTY ACID CONTENT: | 14.1 | 14.2 | 14.2 | 14.3 | 14.4 | 14.5 | 14.5 | 14.6 |
| POLYUNSATURATES CONTENT: | 57.2 | 55.6 | 54.0 | 52.5 | 50.9 | 49.3 | 47.7 | 46.1 |

TABLE 12
Blends of Low Linolenic Soybean Oil and Tri-Oleic Oil

| Fatty Acid Content of Starting Materials: | C8:0 | C10:0 | C12:0 | C16:0 | C18:0 | C18:1 | C18:2 | C18:3 |
|---|---|---|---|---|---|---|---|---|
| Low Linolenic Soybean Oil | — | — | — | 9.7 | 4.3 | 25.3 | 56.0 | 2.8 |
| Tri-Oleic | — | — | — | — | 3.0 | 97.0 | — | — |
| | 12A | 12B | 12C | 12D | 12E | 12F | 12G | 12H |
| Percentage of Starting Materials in Blends: | | | | | | | | |
| Low Linolenic Soybean Oil | 95% | 90% | 85% | 80% | 60% | 55% | 50% | 45% |
| Tri-Oleic | 5% | 10% | 15% | 20% | 40% | 45% | 50% | 55% |
| Fatty Acid Content of Blends: | | | | | | | | |
| Caprylic Acid C8:0 | — | — | — | — | — | — | — | — |
| Capric Acid C10:0 | — | — | — | — | — | — | — | — |
| Lauric Acid C12:0 | — | — | — | — | — | — | — | — |
| Palmitic Acid C16:0 | 9.2 | 8.7 | 8.2 | 7.8 | 5.8 | 5.3 | 4.9 | 4.4 |
| Stearic Acid C18:0 | 4.2 | 4.2 | 4.1 | 4.0 | 3.8 | 3.7 | 3.7 | 3.6 |
| Oleic Acid C18:1 | 28.9 | 32.5 | 36.1 | 39.6 | 54.0 | 57.6 | 61.2 | 64.7 |
| Linoleic Acid C18:2 | 53.2 | 50.4 | 47.6 | 44.8 | 33.6 | 30.8 | 28.0 | 25.2 |
| Linolenic Acid C18:3 | 2.7 | 2.5 | 2.4 | 2.2 | 1.7 | 1.5 | 1.4 | 1.3 |
| SATURATED FATTY ACID CONTENT: | 13.5 | 12.9 | 12.4 | 11.8 | 9.6 | 9.1 | 8.5 | 8.0 |
| POLYUNSATURATES CONTENT: | 55.9 | 52.9 | 50.0 | 47.0 | 35.3 | 32.3 | 29.4 | 26.5 |

TABLE 13
Blends of Low Linolenic Soybean Oil and Corn Oil

| Fatty Acid Content of Starting Materials: | C8:0 | C10:0 | C12:0 | C16:0 | C18:0 | C18:1 | C18:2 | C18:3 |
|---|---|---|---|---|---|---|---|---|
| Low Linolenic Soybean Oil | — | — | — | 9.7 | 4.3 | 25.3 | 56.0 | 2.8 |
| Corn Oil | — | — | — | 11.1 | 2.1 | 25.5 | 59.4 | 1.2 |
| | 13A | 13B | 13C | 13D | 13E | 13F | 13G | 13H |
| Percentage of Starting Materials in Blends: | | | | | | | | |
| Low Linolenic Soybean Oil | 95% | 90% | 85% | 80% | 75% | 70% | 65% | 60% |
| Corn Oil | 5% | 10% | 15% | 20% | 25% | 30% | 35% | 40% |
| Fatty Acid Content of Blends: | | | | | | | | |
| Caprylic Acid C8:0 | — | — | — | — | — | — | — | — |
| Capric Acid C10:0 | — | — | — | — | — | — | — | — |
| Lauric Acid C12:0 | — | — | — | — | — | — | — | — |
| Palmitic Acid C16:0 | 9.8 | 9.8 | 9.9 | 10.0 | 10.1 | 10.1 | 10.2 | 10.3 |
| Stearic Acid C18:0 | 4.2 | 4.1 | 4.0 | 3.9 | 3.8 | 3.6 | 3.5 | 3.4 |
| Oleic Acid C18:1 | 25.3 | 25.3 | 25.3 | 25.3 | 25.4 | 25.4 | 25.4 | 25.4 |
| Linoleic Acid C18:2 | 56.2 | 56.3 | 56.5 | 56.7 | 56.9 | 57.0 | 57.2 | 57.4 |
| Linolenic Acid C18:3 | 2.7 | 2.6 | 2.6 | 2.5 | 2.4 | 2.3 | 2.2 | 2.2 |
| SATURATED FATTY ACID CONTENT: | 14.0 | 13.9 | 13.9 | 13.8 | 13.8 | 13.8 | 13.7 | 13.7 |
| POLYUNSATURATES CONTENT: | 58.9 | 59.0 | 59.1 | 59.2 | 59.3 | 59.3 | 59.4 | 59.5 |

1. An edible oil blend of a first edible oil and a second edible oil, wherein the first edible oil is low linolenic soybean oil, and the edible oil blend has a linolenic acid content of about 6% or less and is virtually trans free.

2. The edible oil blend of claim 1, wherein the edible oil blend has a linolenic acid content of about 4% or less, and is substantially free of antioxidants.

3. The edible oil blend of claim 1, wherein the blend comprises less than 1% by weight trans fats.

4. The edible oil blend of claim 1, wherein the blend comprises at least about 40% low linolenic soybean oil.

5. The edible oil blend of claim 1, wherein the blend comprises at least about 90% low linolenic soybean oil.

6. The edible oil blend of claim 1, wherein the blend comprises about 45% low linolenic soybean oil, about 45% high oleic canola oil, and about 10% palm stearin.

7. The edible oil blend of claim 1, wherein the blend comprises about 92% low linolenic soybean oil and about 8% palm stearin.

8. A method for preparing the edible oil blend of claim 1, wherein the method comprises blending a first edible oil and a second edible oil in amounts sufficient to provide an edible oil blend having an acid content of about 6% or less and which is virtually trans free.

9. The method of claim 8 wherein the first edible oil and the second edible oil are blended in amounts sufficient to provide an edible oil blend having a linolenic content of about 4% or less.

10. The method of claim 8, further comprising blending the first edible oil and the second edible oil in amounts sufficient to provide the edible oil blend with a linoleic acid content of about 56% or less.

11. The method of claim 8, further comprising blending the first edible oil and the second edible oil in amounts sufficient to provide the edible oil blend with an oleic acid content of about 15% or more, a saturated fatty acid content of about 49% or less.

12. The method of claim 8, wherein at least one of the edible oil blend, the first edible oil, or the second edible oil is processed by brush hydrogenation.

13. The method of claim 8, wherein at least one of the edible oil blend, the first edible oil, or the second edible oil is processed by interesterification.

14. The method of claim 8, wherein at least one of the edible oil blend, the first edible oil, or the second edible oil is processed by hydrogenation in the presence of a conditioned catalyst, wherein the conditioned catalyst comprises a catalyst composition having a plurality of active sites which are conditioned with a conditioning chemical.

15. The method of claim 14, wherein the catalyst composition is a narrow pore selective nickel catalyst composition, and the conditioning chemical is selected from the group consisting of a phosphoric acid, an organic acid phosphate, and combinations thereof.

16. A method for preparing a food, comprising combining the food with the edible oil blend of claim 1.

17. The method of claim 16, comprising the steps of heating the edible oil blend and cooking the food.

18. An edible oil blend having a linolenic acid content of about 6% or less, which is virtually trans free.

19. An edible oil blend comprising first and second oils selected from the oils having the fatty acid profiles described in Tables 1 through 13, wherein the edible oil blend has the first and second oils in amounts described in Tables 1 through 13.

20. A method for preparing an edible oil blend having a desired fatty acid content, the method comprising selecting a target fatty acid content; and blending a first edible oil and a second edible oil in amounts sufficient to provide an edible oil blend having the target fatty acid content where the first edible oil is a low linolenic soybean oil.

21. The method of claim 20, wherein the target fatty acid content is a target linolenic acid content.

22. The method of claim 20, wherein the target fatty acid content is a target linoleic acid content.

23. The method of claim 20, wherein the target fatty acid content is a target polyunsaturated fatty acid content.

24. The method of claim 20, wherein the target fatty acid content is a target oleic acid content.

25. The method of claim 20, wherein the second edible oil is selected from the group consisting of canola oil, cottonseed oil, safflower oil, soybean oil, olive oil, sunflower oil, palm oil, MCT oil, partially hydrogenated soybean oil, and trioleic oil.

26. A method for preparing a normalized edible oil blend having a desired fatty acid content, the method comprising:
selecting a desired fatty acid content for a normalized edible oil blend; and
blending a first edible oil and a second edible oil in amounts sufficient to provide an edible oil blend having an actual fatty acid content where the first edible oil is a low linolenic soybean oil;
wherein the actual fatty acid content is within three percentage points of the desired fatty acid content.
